(19) United States
(12) Patent Application Publication
(10) Pub. No.: US 2025/0300597 A1
(43) Pub. Date: Sep. 25, 2025

(54) SELF-DEPLOYING PHOTOVOLTAIC POWER SYSTEMS

(71) Applicant: PacMar Technologies LLC, Honolulu, HI (US)

(72) Inventors: Steven Loui, Honolulu, HI (US); Christopher Hart, Kingston, RI (US); Gary Shimozono, Honolulu, HI (US); Michael Buelsing, Honolulu, HI (US)

(21) Appl. No.: 19/069,067

(22) Filed: Mar. 3, 2025

Related U.S. Application Data
(60) Provisional application No. 63/567,328, filed on Mar. 19, 2024.

(51) Int. Cl. H02S 30/20; G05D 3/10; H02S 10/40; H02S 20/30; H02S 20/32; H02S 40/38

(52) U.S. Cl. CPC H02S 30/20; G05D 3/105; H02S 10/40; H02S 20/32; H02S 20/30; H02S 40/38

(57) ABSTRACT

Systems and methods are provided for self-deploying photovoltaic power systems. In one example, a self-deploying photovoltaic power system may include an inflatable base panel, a photovoltaic element, and an inflator element, wherein the inflator element may unroll, inflate, and adjust the self-deploying photovoltaic power system according to conditions using energy collected from the solar panels. Additionally, energy form the solar panels may be stored in a battery and/or directed to a device.

### CROSS REFERENCE TO RELATED APPLICATIONS

The present application claims priority to U.S. Provisional Application No. 63/567,328, entitled “SELF-DEPLOYING PHOTOVOLTAIC POWER SYSTEMS”, and filed on Mar. 19, 2024. The entire contents of the above-listed application(s) are hereby incorporated by reference for all purposes.

### TECHNICAL FIELD

The present description relates generally to self-deploying photovoltaic power systems.

### BACKGROUND AND SUMMARY

Power systems may be used to provide energy for storage or usage. For example, photovoltaic cells may be used in a solar power system to convert light into electrical energy, which may be stored in a battery and/or used to power electrical devices. Under some conditions, a portable (e.g., easily transported) power system may be demanded. For example, applications where a user may operate electrical devices in areas without access to a permanent or fixed power source (e.g., electric grid), such as in a remote location, may demand a portable power source that is rechargeable with natural resources (e.g., solar energy). Thus, current power sources (e.g., grid, microgrid, generator, installed solar panels, or standalone battery) may not meet both the energy demands and portability demands of such applications, for example due to energy storage capacity, recharging ability, weight, shape, and/or volume.

Thus, embodiments are disclosed herein that solve at least some of the issues described above with a self-deploying photovoltaic power system, comprising: an inflatable base, wherein the base is a dropstitch panel with one or more inlet ports; a photovoltaic element arranged on a surface of the inflatable base, wherein the photovoltaic element comprises photovoltaic material; an inflatable tilting element with one or more outlet ports, wherein the tilting element is adapted to adjust an angle of the base; an inflator element adapted to inflate the base and the tilting element using a portion of energy captured by the photovoltaic element; an energy storage element configured to store additional energy captured by the photovoltaic element. The photovoltaic power system may be deflated and rolled into a compact form for transportation. In this way, the photovoltaic power system may have reduced weight and stored volume. Further, the photovoltaic power system may be self-inflating to further contribute to portability. Further still, the photovoltaic power system may adjust a tilt angle of the base and photovoltaic element during operation to maximize solar energy capture, thus increasing an efficiency of the photovoltaic power system.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows a schematic depiction of a first example of a self-deploying photovoltaic power system.

FIG. 2 shows a second example of a self-deploying photovoltaic power system.

FIG. 3 shows a third example of a self-deploying photovoltaic power system.

FIG. 4 shows a flowchart of a method for operating a self-deploying photovoltaic power system.

FIG. 5 shows a flowchart of a method for determining a desired angle adjustment of a self-deploying photovoltaic power system.

FIG. 6 shows a flowchart of a method for adjusting an angle of a self-deploying photovoltaic power system.

FIG. 7 shows a schematic depiction of a fourth example of a self-deploying photovoltaic power system.

FIG. 8 shows a schematic depiction of a fifth example of a self-deploying photovoltaic power system.

FIG. 9 shows a schematic depiction of an example of more than one self-deploying photovoltaic power systems coupled in parallel.

FIG. 10 shows an example of an unrolled self-deploying photovoltaic power system.

FIG. 11 shows an example of a rolled self-deploying photovoltaic power system.

### DETAILED DESCRIPTION

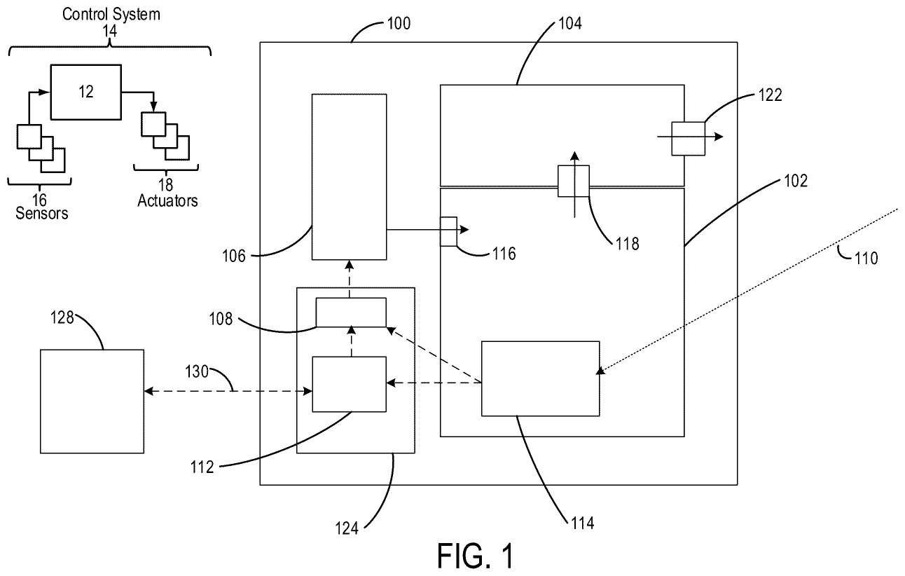

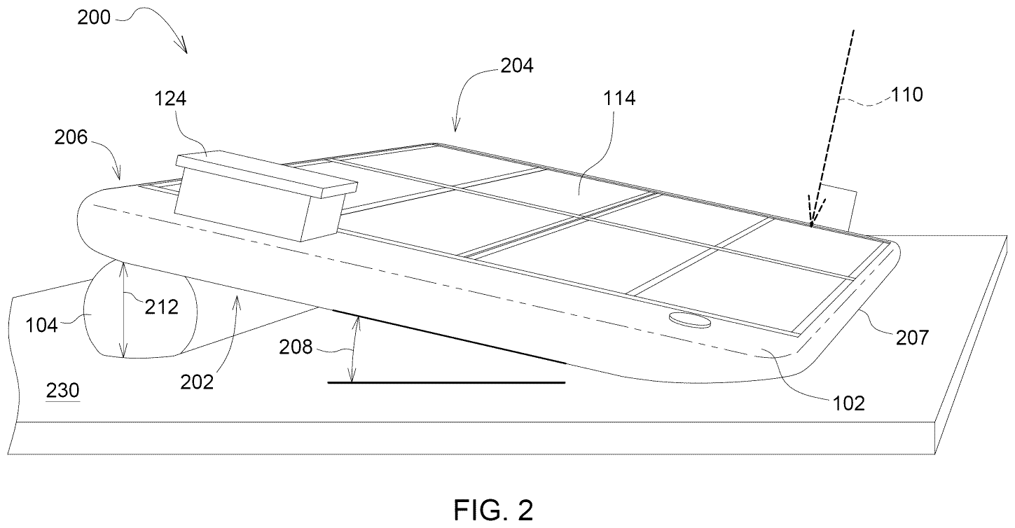

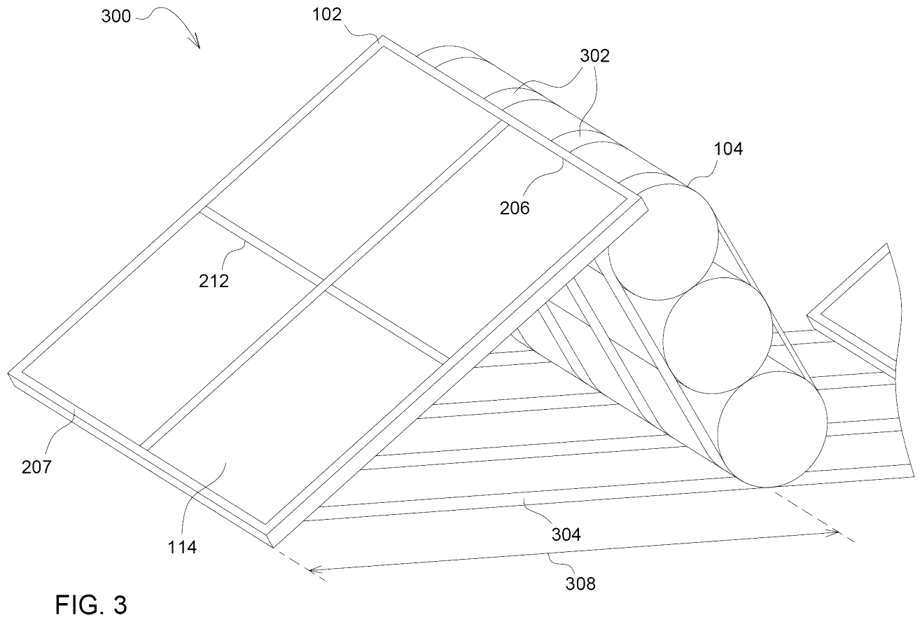

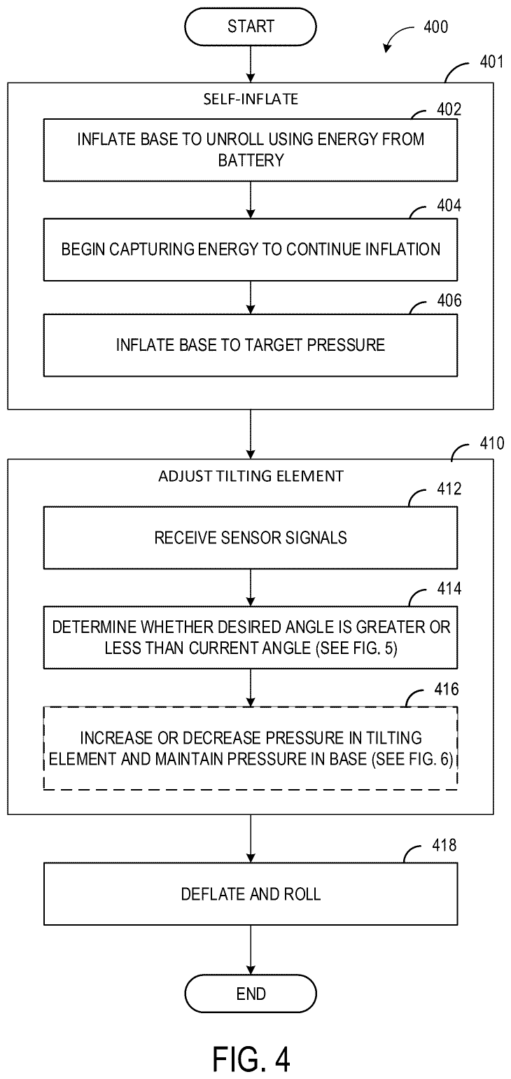

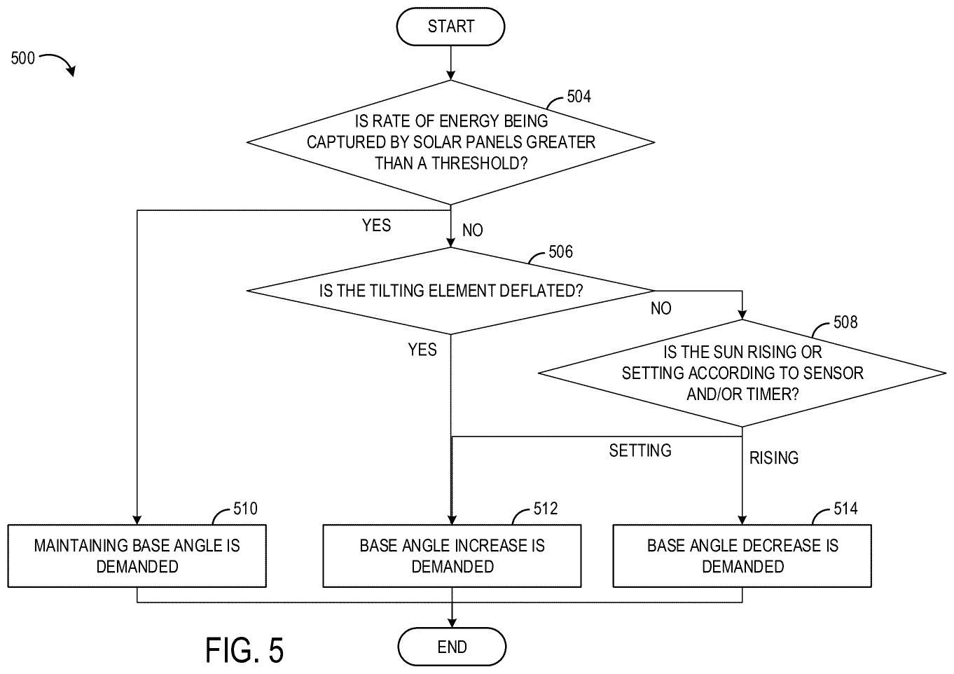

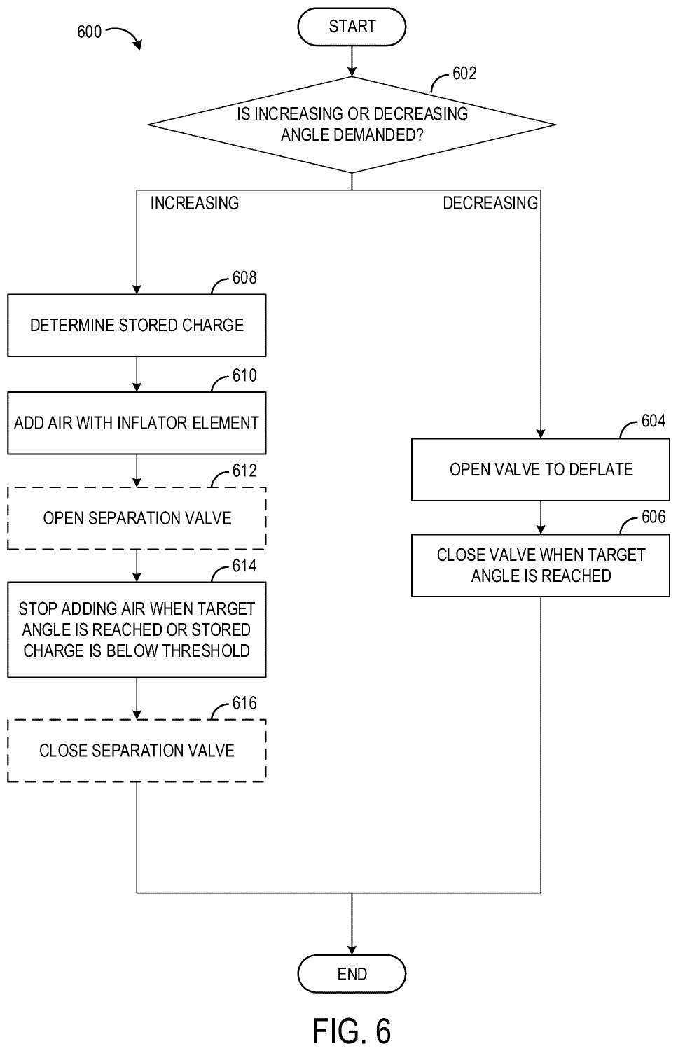

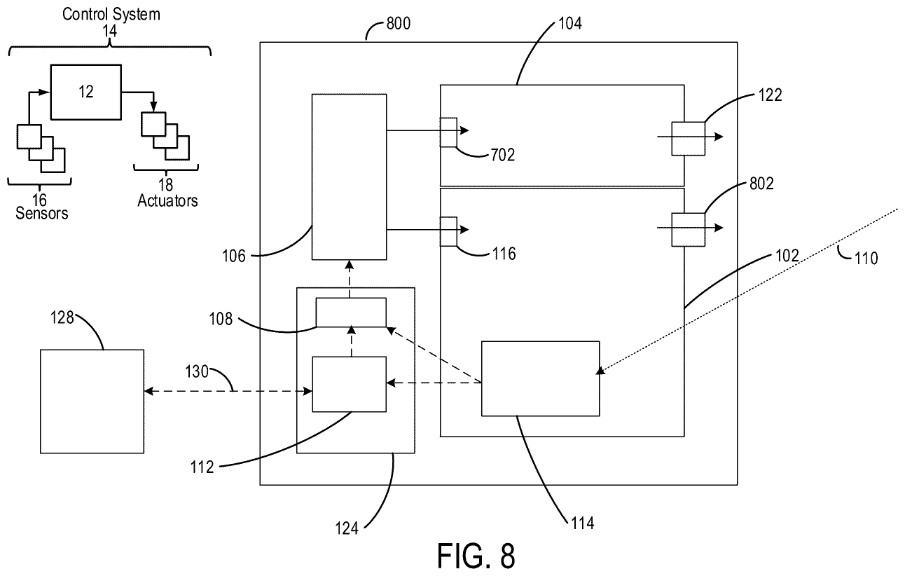

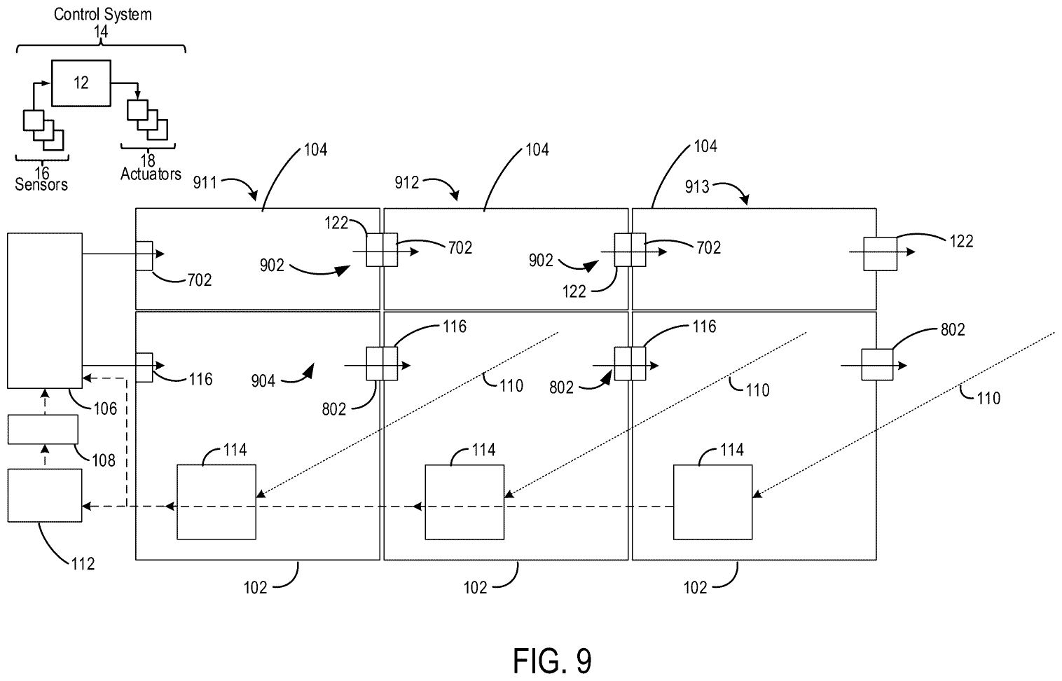

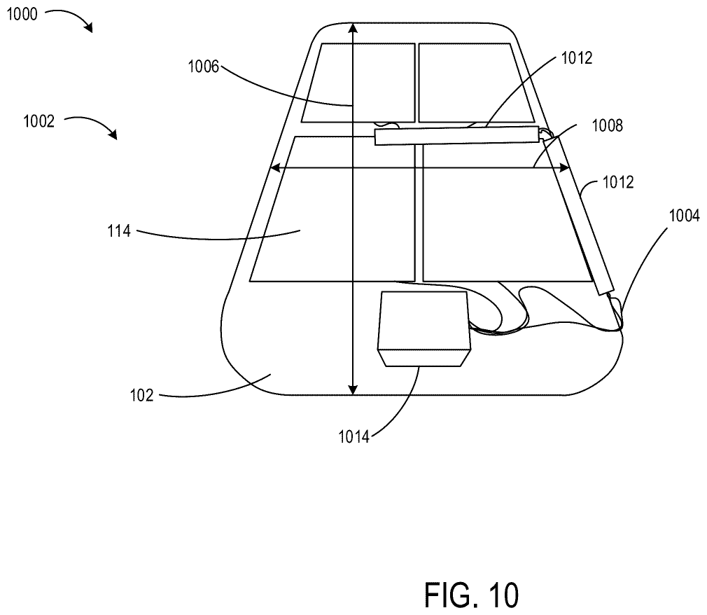

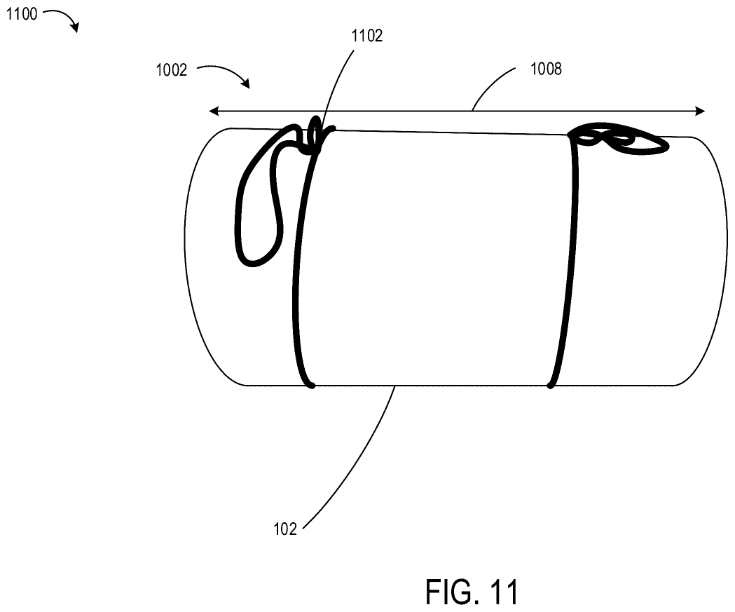

The following description relates to systems and methods for self-deploying photovoltaic power systems. For example, a self-deploying photovoltaic power system may include an inflatable base, a photovoltaic element arranged on or integrated with (e.g., embedded within) the inflatable base, an inflatable tilting element, an inflator element, an energy storage element, a control system, one or more inlet ports, and one or more outlet ports. The inflatable tilting elements may be used to adjust an angle of the base with the surface on which it is placed, thus adjusting an angle of the energy storage element. FIGS. 1, 7, and 8 show schematic examples of self-deploying photovoltaic power systems with varying configurations of inlet ports and outlet ports. The inlet ports and outlet ports may be valves, and may be adapted to link self-deploying photovoltaic power systems in parallel. For example, FIG. 9 shows a schematic of multiple of the example self-deploying photovoltaic power system of FIG. 8 connected in parallel. In this way, energy demands for different applications may be met by using an appropriate number of self-deploying photovoltaic power systems. That is, modularity of the self-deploying photovoltaic power system allows for scaling to meet greater energy demands without adjusting the dimensions thereof. FIGS. 2 and 3 show examples of a tilting element comprising a single inflatable cylinder and comprising multiple inflatable cylinders, respectively, incorporated into self-deploying photovoltaic power systems. FIG. 4 shows a flowchart of an example method of operating a self-deploying photovoltaic power system, such as the example self-deploying photovoltaic power systems of FIGS. 1-3 and 7-9. The method of FIG. 4 may include determining a desired angle adjustment and adjusting the tilting element accordingly, which are processes further expanded upon in methods of FIGS. 5 and 6, respectively. A self-deploying photovoltaic power system such as the example shown in FIG. 10 may also be deflated and rolled for easier transportation, such as shown in FIG. 11. Thus, a self-deploying photovoltaic power system may be portable, rechargeable with natural resources, scalable to energy demands, and self-inflatable. For example, the self-deploying photovoltaic power system may be containerized for protection and easier handling and transportation, particularly in multiple quantities. Further, the self-deploying photovoltaic power system may also be configured to be airdropped from an aircraft, such as a cargo plane, helicopter, drone, or the like.

As used herein, “inflated” may indicate the referenced component is in an inflated state, wherein the component's shape is resistant to bending, folding, rolling, and the like. As used herein, “deflated” may indicate the referenced component is easily bent, folded, rolled, and the like, and has an internal pressure approximately equivalent to atmospheric pressure (e.g., 1 atm). A component may also be partially inflated, which may include states between deflated and inflated (e.g., bendable and having a greater internal pressure than 1 atm).

It is also to be understood that the specific assemblies and systems illustrated in the attached drawings, and described in the following specification are exemplary embodiments of the inventive concepts defined herein. For purposes of discussion, the drawings are described collectively. Thus, like elements may be commonly referred to herein with like reference numerals and may not be re-introduced.

Turning to FIG. 1, a first exemplary self-deploying photovoltaic power system 100 is schematically depicted. The self-deploying photovoltaic power system 100 may include one or more of a photovoltaic element 114, an energy storage element 112, an inflatable base 102, an inflatable tilting element 104, and an inflator element 106 which may inflate the base 102 and the tilting element 104. For example, the photovoltaic element 114 may receive light and produce electrical energy which may be stored (e.g., in the energy storage element 112) and/or used (e.g., by the inflator element 106).

The tilting element 104 may adjust a base angle (e.g., base angle 208 described below with reference to FIG. 2) of the base 102 with a surface upon which the base 102 is placed, thereby adjusting an angle of the photovoltaic element 114 arranged on the base 102. For example, a degree of inflation of the tilting element 104 may be increased to increase the base angle, and the degree of inflation of the tilting element 104 may be decreased to decrease the base angle. Adjusting the base angle may be desired to increase energy generation of the photovoltaic element 114. For example, adjusting the base angle may be performed to position the photovoltaic element 114 perpendicular to light rays (e.g., light ray 110) induced thereupon, for example, from the sun. The photovoltaic element 114 may be positioned closer to perpendicularly with incident light by the tilting element 104 in order to increase energy capture of the self-deploying photovoltaic power system 100. For example, if incident light is at a 60 degree angle with the photovoltaic element 114, the base angle may be adjusted by the tilting element 104 such that the angle of incident light with the photovoltaic element 114 is increased to within a threshold angle of 90 degrees. For example, the threshold angle may be between 0 and 20 degrees, such that the angle of incident light with the photovoltaic element 114 may be between 70 and 90 degrees. The threshold angle may depend on external factors such as time of day. For example, the threshold angle may be decreased during the morning and increased in the evening. In this way, the tilting element 104 may position the photovoltaic element 114 perpendicularly or closer to perpendicularly with the incident light, thereby increasing an amount of energy captured. The tilting element 104 may take a variety of forms without departing from the scope of this disclosure.

For example, now referencing FIG. 2, the tilting element 104 may comprise a single inflatable cylinder such as shown in self-deploying photovoltaic power system 200. The tilting element 104 may be coupled to a bottom surface 202 of the base 102, and the photovoltaic element 114 may be coupled to a top surface 204 of the base 102. The top surface 204 may be opposite the bottom surface 202. For example, the top surface 204 and the bottom surface 202 may be in parallel planes and facing outwards in opposite directions. Further, the tilting element 104 may be positioned adjacent to an edge 206 (e.g., closer to the edge 206 than the edge 207) of the base 102 and may be axially parallel with the edges 206, 207. In this way, the inflatable cylinder may raise the edge 206 (e.g., away from a surface 230 beneath the self-deploying photovoltaic power system 200 such as a surface of a structure, surface of a body of water, etc.) when inflated such that distance 212 and base angle 208 may be increased. Decreasing the degree of inflation of the tilting element 104 may reduce the distance 212 and thereby decrease the base angle 208. As described above, a specific base angle 208 may be desired to align the photovoltaic element 114 perpendicularly with incident light, such as the light ray 110. Thus, efficiency of the photovoltaic element 114 may be increased by adjusting the inflation of the tilting element 104 to achieve a desired base angle 208 according to environmental conditions (e.g., time of day, sun angle, etc.).

In other examples, the tilting element 104 may comprise multiple (e.g., two or more) inflatable cylinders such as in shown in self-deploying photovoltaic power system 300 of FIG. 3. Referring now to FIG. 3, the tilting element 104 may be positioned at the edge 206 as described with regards to FIG. 2. Further, the tilting element 104 may include two or more inflatable cylinders, arranged parallel to and in face sharing contact with one another. The two or more inflatable cylinders may be fluidly coupled (e.g., where fluid such as air can exchange between the two or more inflatable cylinders) in some examples, such that the two or more inflatable cylinders may be inflated concurrently. In other examples, the two or more inflatable cylinders may be sealed such that they may be inflated separately. In yet other examples, the two or more inflatable cylinders may be connected via valves therebetween which may be pressure sensitive and/or communicatively coupled to a controller, which may send signals to open and close the valves. In this way, inflation may be more specifically controlled by selectively fluidically coupling via the valves. The two or more inflatable cylinders may be held in position by one or more straps 302. The one or more straps 302 may secure the self-deploying photovoltaic power system 300 to a set of tracks 304. Further, the edge 207 may be coupled to the tracks 304 at a distance 308 from where the straps couple the tilting element 104 to the tracks 304. Thus, the base angle 208 may be decreased or increased by increasing or decreasing the distance 308, respectively, in addition or alternative to adjusting inflation of the tilting element 104.

The tracks 304 may also be used to link two or more self-deploying photovoltaic power systems 300 together in a variety of configurations. For example, the self-deploying photovoltaic power systems 300 may be connected in series, wherein the edge 206 of a first self-deploying photovoltaic power system is adjacent and parallel to the edge 207 of a second self-deploying photovoltaic power system, and so on. The self-deploying photovoltaic power systems 300 may also be connected in parallel, wherein the edges 206 of each self-deploying photovoltaic power system are aligned (e.g., collinearly) along a common axis.

Thus, the efficiency of the photovoltaic element 114 may be increased by adjusting the tilting element 104 to achieve a desired base angle 208 according to operating conditions (e.g., time of day, sun angle, etc.). Further, the tilting element 104 may have other shapes than described in the examples above (e.g., non-cylindrical) without departing from the scope of this disclosure. For example, the tilting element 104 may be shaped as a triangular prism with an accordion folded edge that increases the base angle upon inflation.

Returning to FIG. 1, adjusting the base angle (e.g., base angle 208) may be actuated by the inflator element 106, for example by using electrical energy generated by the photovoltaic element 114. Electrical energy generated by the photovoltaic element 114 may be directed to the energy storage element 112 wherein the electrical energy may be stored. Further, electrical energy stored in the storage element 112 may be directed to the inflator element 106. In some examples, there may be a current conversion element 108 positioned between the photovoltaic element 114 and the inflator element 106, such that the photovoltaic element 114 and the inflator element 106 are coupled via the current conversion element 108. The energy storage element 112 and the current conversion element 108 may be housed within in a shared housing 124, in some examples. For example, the current conversion element 108 may convert direct current (DC) to alternating current (AC) or vice versa. Thus, electrical energy may be transmitted from the photovoltaic element 114 (or the energy storage element 112), to the current conversion element 108, and then to the inflator element 106. The inflator element 106 may use the electrical energy captured by the photovoltaic element 114 to inflate the base 102 and the tilting element 104. Thus, the self-deploying photovoltaic power system 100 may be self-inflating, or self-deploying, and may be referred to as such herein.

Further, one or more external devices 128 may be electrically coupled to the self-deploying photovoltaic power system 100 via a coupling indicated by arrow 130. For example, ports may be added to electrically couple one or more external devices 128 (e.g., portable battery, light, antenna, sensor, unmanned underwater vehicle battery, unmanned aerial vehicle battery, other rechargeable battery, etc.) to the energy storage element such that the devices 128 may be powered by the energy captured by the self-deploying photovoltaic power system 100. The electrical coupling indicated by arrow 130 may transfer power wirelessly (e.g., inductively) and/or via conductive elements (e.g., one or more power transmission cables). Energy may be directed from the energy storage element 112 to the devices 128 in order to charge and/or power the devices 128. Additionally or alternatively, energy may be directed from the photovoltaic element 114 to the devices 128 in order to charge and/or power the devices 128, which may be more efficient than charging the devices 128 via the energy storage element 112.

For example, the external devices 128 may include batteries (e.g., of phones, lights, vehicles, etc.) which may be charged using energy from the self-deploying photovoltaic power system 100. The external devices 128 may additionally or alternatively include vehicles, such as unmanned vehicles (e.g., unmanned surface, underwater, and/or aerial vehicles). In this way, the self-deploying photovoltaic power system 100 may function as a recharging station for one or more devices, such as for the unmanned vehicles. Additionally or alternatively, the self-deploying photovoltaic power system may be deployed from or coupled to a vehicle, such as an unmanned surface vessel, to extend the vehicle's range (e.g., by providing power to the vehicle) and/or to serve as a mobile recharging station for other vehicles. The coupling indicated by arrow 130 may also be configured such that the coupling can engage and disengage to enable various operational use cases. It will be appreciated that while the external devices 128 are shown as being electrically coupled to the energy storage element 112, the external devices 128 may be electrically coupled to the self-deploying photovoltaic power system 100 in other configurations, such as being directly coupled to the photovoltaic element 114. In some examples, the self-deploying photovoltaic power system 100 may also receive power from the external devices 128 as indicated by the arrow 130 being bidirectional.

For example, the inflator element 106 may be a pump, a compressed air canister with a controlled release system, or the like. As used herein, “air” may include atmospheric air (e.g., oxygen, nitrogen, etc.), any pure gas (e.g., carbon dioxide gas), or combination of gasses. The inflator element 106 may direct pressurized air through an inlet port 116 into the base 102. Further, the inflator element 106 may include one or more pumps and/or one or more compressed air canisters. As such, there may be more than one inlet port 116 in some examples. Air may be transferred from the base 102 to the tilting element 104 via a separation valve 118. For example, the separation valve 118 may be pressure sensitive such that air is transmitted from the base 102 to the tilting element 104 via the separation valve 118 when a pressure in the base 102 exceeds a threshold. For example, the threshold may be a minimum pressure to reach a desired stiffness of the base 102 such that the base 102 may maintain an inflated shape while folding and bending thereof are prevented. For example, the base 102 may maintain a flat panel shape when inflated to the threshold pressure. In this way, pressure in the base 102 may be maintained at a threshold while pressure in the tilting element 104 is being adjusted, allowing the base 102 to maintain a desired shape during use while adjusting the shape of the tilting element 104. Thus, the base angle may be adjusted without affecting the shape of the base 102.

The self-deploying photovoltaic power system 100 may further comprise a control system 14, including a controller 12, a plurality of sensors 16, and a plurality of actuators 18. For example, the sensors 16 may include pressure sensors. Pressure sensors may fluidically couple to interiors of the base 102 and the tilting element 104 such that pressures thereof may be measured, for example to determine degrees of inflation thereof. For example, in response to a pressure sensor detecting an undesired increase in pressure of the tilting element 104 (e.g., due to increase in ambient temperature), the controller 12 may signal an actuator to open an outlet port 122 (e.g., a valve). Additionally or alternatively, the outlet port 122 may be pressure sensitive similar to the separation valve 118 such that the outlet port 122 opens in response to a second threshold pressure being exceeded in the tilting element 104. As another example, in response to pressure in the base 102 dropping undesirably, the controller 12 may send a signal for the inflator element 106 to push air into the base 102. Thus, the inflator element 106 may be considered an actuator 18. The sensors 16 may also include current sensors and/or photodetectors, measurements of which may be used by the controller 12 to determine an efficiency of the photovoltaic element 114 and/or whether to adjust the tilting element 104. For example, current sensors may electrically couple to the photovoltaic element 114 such that current of the electrical energy produced may be measured. Further, photodetectors may measure light exposure of the self-deploying photovoltaic power system 100. Thus, in combination, comparing light exposure and energy generation may contribute to determining if the photovoltaic element 114 may produce more energy by adjusting the base angle. Additional sensors may detect state of charge (e.g., as a percentage of the maximum charge capacity) of the energy storage element 112, for example.

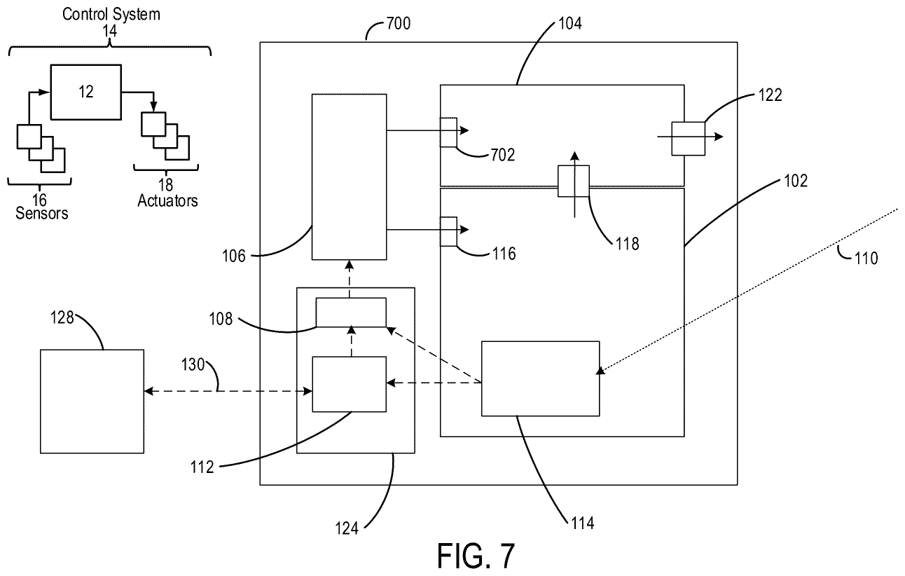

Turning to FIG. 7, another example of a self-deploying photovoltaic power system 700 is shown schematically. The self-deploying photovoltaic power system 700 may include the components of the self-deploying photovoltaic power system 100, and may further include a second inlet port 702 through which air may be delivered directly to the tilting element 104. In this way, the self-deploying photovoltaic power system 700 may include two inlet ports and a single outlet port. For example, inflation may be controlled separately to the base 102 and the tilting element 104 due to the second inlet port 702 being independent of the inlet port 116. In this way, complexity of the separation valve 118 may be reduced such that the separation valve 118 may not regulate pressure of the base 102 as the tilting element 104 is adjusted. Therefore, the separation valve 118 may be an electric valve that opens and closes on request of the controller 12 rather than pressure-sensitive and electrically controlled. Air may flow directly to the tilting element 104 via the second inlet port 702 rather than passing through the base 102 and then flowing into the tilting element 104 via the separation valve 118. The separation valve 118 may be opened when deflation of the base is demanded and remain closed otherwise.

The inflator element 106 of the self-deploying photovoltaic power system 700 may include a single pump or compressed air container with couplings to both the inlet port 116 and the second inlet port 702. Alternatively, the inflator element 106 may include two or more pumps and/or compressed air containers. In examples wherein the inflator element includes two pumps and/or compressed air containers, each pump and/or compressed air container may be connected to one of the inlet port 116 and the second inlet port 702. In this way, inflation mechanisms of the base 102 and the tilting element 104 may be further separated, allowing for more independent control.

Turning to FIG. 8, another example of a self-deploying photovoltaic power system 800 is schematically depicted. The self-deploying photovoltaic power system 800 may include a second outlet port 802 and may not include a separation valve between the base 102 and the tilting element 104 (e.g., the separation valve 118 of FIGS. 1 and 7). In this way, the self-deploying photovoltaic power system 800 may include two inlet ports and two outlet ports. Thus, a first inflation (e.g. pressure) of the base 102 and a second inflation pressure of the tilting element 104 may be independent in the self-deploying photovoltaic power system 800. Thus, more specific control over different pressures of different inflatable elements of the self-deploying photovoltaic power system 800 may be achieved in such a configuration. Further, a first self-deploying photovoltaic power system 800 may be more easily attached to a second self-deploying photovoltaic power system 800 in parallel, though attachment such as in a parallel configuration is possible for other configurations including the self-deploying photovoltaic power systems 100, 200, 300, and 700.

Turning to FIG. 9, a schematic is shown of an example of a plurality of self-deploying photovoltaic power systems, each self-deploying photovoltaic power system having two inlet ports and two outlet ports as described above with respect to the self-deploying photovoltaic power system 800 of FIG. 8, connected in parallel. For example, a tilting element connection 902 may be formed between the outlet port 122 of a first inflatable element 911 (wherein an inflatable element includes the base 102 and the tilting element 104) and a second inlet port 702 of a second inflatable element 912. Likewise, a tilting element connection may be formed between the outlet port 122 of the second inflatable element 912 and a second inlet port 702 of a third inflatable element 913. Thus, the outlet ports 122 may be adapted to couple with the second inlet ports 702. Further, a base connection 904 may be formed between the second outlet 802 of the first inflatable element 911 and the inlet port 116 of the second inflatable element 912 and a base connection 904 may be formed between the second outlet 802 of the second inflatable element 912 and the inlet port 116 of the third inflatable element. Thus, the second outlet ports 802 may be adapted to couple to the inlet ports 116.

In this way, the tilting elements 104 of the first inflatable element 911, the second inflatable element 912, and the third inflatable element 913 may be fluidically coupled via the tilting element connections 902, and the bases 102 of the first inflatable element 911, the second inflatable element 912, and the third inflatable element 913 may be fluidically coupled via the base connections 904. Thus, the first inflatable element 911, the second inflatable element 912, and the third inflatable element 913 may share a single inflator element 106, in some examples. Further, electric couplings may be made between the photovoltaic elements 114, so that a single energy storage element 112 may be shared by the photovoltaic elements 114. In this way, the first inflatable element 911, the second inflatable element 912, and the third inflatable element 913 may be more easily transported as compact subunits and combined into a larger system to meet energy demands (depending on an application), than in alternative systems where more than one energy storage element and/or more than one inflator element are included. In other examples, there may be two or more inflatable elements chained together as shown in FIG. 9.

In some embodiments, a self-deploying photovoltaic power system may include additional components to those described with reference to FIGS. 1-3 and 7-9 above. For example, an electric thruster (e.g., motor, electric propeller, etc.) may be included for dynamic positioning of a self-deploying photovoltaic power system. The electric thruster may be powered by energy captured by the photovoltaic element and/or the energy storage element. Additionally or alternatively, a self-deploying photovoltaic power system may have an anchoring system, such as a small anchor with a spool of fine spectra or monofilament that self-deploys upon self-inflation. Further, some examples may include two or more tilting elements (e.g., the tilting element 104 of FIG. 1). In such examples, the two or more tilting elements may be adapted to adjust an angle of incident light in one or more degrees of freedom. For example, two tilting elements such as inflatable cylinders may be arranged on adjacent perpendicular edges. In this way, the base angle may be adjusted with two degrees of freedom. In another example, a tilting element may be positioned along each edge of a base, such that the base angle may be adjusted in a plurality of directions. In this way, the self-deploying photovoltaic power system may self-adjust to align the photovoltaic element more perpendicularly with incident light (e.g., the light ray 110 of FIGS. 1 and 2).

Further, self-deploying photovoltaic power systems may also be deflatable. For example, to deflate the self-deploying photovoltaic power system 100, the outlet port 122 and the separation valve 118 may be opened, thus allowing air to exit the base 102 and the tilting element 104. Following deflation, the self-deploying photovoltaic power system 100 may be rolled into a compact form for increased portability. An automated rolling system may be used to roll the self-deploying photovoltaic power system into compact form (e.g., a motorized mandrel).

FIGS. 10 and 11 show a self-deploying photovoltaic power system 1002 in an inflated form 1000 and a compact form 1100, respectively. In some examples, the base 102 may be a rectangular panel shape when in the inflated form 1000, with a significantly smaller thickness than length 1006 and width 1008. In other examples, the base 102 may take other shapes, such as circular, triangular, and the like. Further, the base 102 shape may include additional features such as run tunnels or pockets 1012 for holding wire runs 1004 in place. The wire runs 1004 may electrically couple components such as shown by dashed lines in FIGS. 1, 7, and 8. For example, the wire runs 1004 may electrically couple the photovoltaic element 114 to one or more electrical components housed in a housing 1014 which may include the energy storage device 112, the current conversion element 108, the inflator element 106, and/or the controller 12. When deflated, the base 102 may be rolled into the compact form 1100. As such, a rectangular base may be desired due to ease of rolling compactly compared to other shapes. As described above, the base 102 may be constructed of dropstitch. Further, a dropstitch layer of the base 102 may be coated with one or more layers. For example, an outer surface of the dropstitch layer may be covered by a coating (e.g., film of even thickness over outer surfaces), wherein the coating may be a material that forms a hermetic seal between the dropstitch layer and the surrounding environment. The coating layers may also include materials that introduce or enhance energy conversion behavior of the photovoltaic element 114.

The photovoltaic element 114 may comprise photovoltaic material, and may be arranged on and/or integral with the base 102. The photovoltaic element 114 may be embedded within the base 102, in some examples. Further, the photovoltaic material may be applied (e.g., printed, laminated, or adhered) such that the photovoltaic material may be flexible (e.g., able to change shape repeatedly without degradation or reduction in function). For example, the photovoltaic material may be integrated into yarn used to construct the base 102. In another example, the photovoltaic material may be printed onto woven fabric (e.g., dropstitch material) prior to coating, or applied as a flexible thin film below or above the airtight coating. In yet another example, the photovoltaic material may be formed into one or more flexible sheets that are adhered to the base 102. In this way, the self-deploying photovoltaic power system may be rolled, adjusted, inflated, deflated, unrolled, etc. while maintaining function of the photovoltaic material of the photovoltaic element 114 (e.g., not reducing efficiency or effectiveness).

For example, as shown in FIG. 11, the self-deploying photovoltaic power system 1002 may be rolled into the compact form 1100. When rolled, the compact form may be a cylindrical shape with a length equal to the width 1008 as shown, or the length 1006 of FIG. 10. Further, there may be one or more fasteners 1102 (e.g., ropes, hook and loop fasteners, snaps, buckles, or the like) which hold the self-deploying photovoltaic power system 1002 in the compact form 1100. In this way, the compact form 1100 may allow a user to more easily transport the self-deploying photovoltaic power system 1002 than other power sources with similar capacity for energy storage and generation. Further still, the compact form 1100 may transition back to the unrolled, inflated form 1000 by self-deploying through a self-inflating method such as part of the method 400 of FIG. 4.

Turning to FIG. 4, a flowchart of a method is shown for operating a self-deploying photovoltaic power system, such as the self-deploying photovoltaic power system examples shown in FIGS. 1-3 and 7-11. As such, the self-deploying photovoltaic power system may include a base, a tilting element, a photovoltaic element, an energy storage element, and an inflator, wherein the energy from the photovoltaic element may be directed to the energy storage element or the inflator and the inflator may inflate the base and the tilting element. Further, the self-deploying photovoltaic power system may include a control system, including a controller (e.g., the controller 12 of FIGS. 1, 7, and 8), one or more sensors (e.g., sensors 16 of FIGS. 1, 7, 8), and one or more actuators (e.g., actuators 18 of FIGS. 1, 7, and 8). The method 400 may be initiated by the controller and carried out according to instructions stored in memory thereof (e.g., non-volatile memory). At the start of the method 400, the self-deploying photovoltaic power system may be in a compact form, such as the compact form 1100 shown in FIG. 11, wherein the base is rolled.

The method 400 begins at 401, wherein the self-deploying photovoltaic power system self-inflates. Self-inflating may include several steps, starting with inflating the base to unroll using energy from the energy storage element at 402. Fasteners, such as the fasteners 1102 may be unfastened (e.g., automatically or by action of a user), such that the base may be allowed to expand and unroll upon inflation. To accomplish this, the inflator may direct air to enter the base while air is not allowed to flow between the base and the tilting element. A valve between the base and the tilting element (if included, such as the separation valve 118 in examples of FIGS. 1 and 7) may be closed to fluidically separate the base and the tilting element. In this way, the base may be inflated and the tilting element may remain deflated. Inflating the base may be prioritized over inflating the tilting element to ensure the photovoltaic element is exposed to light more quickly than if the inflation were not controlled in this way. Thus, an amount of power demanded from the energy storage element in order to self-inflate may be minimized.

Following 402, the method 400 proceeds to 404 wherein the photovoltaic element begins capturing energy to continue self-inflating the self-deploying photovoltaic power system. The photovoltaic element may convert light into electrical energy which may be used to power the inflator element. In a first example, electrical energy may be directed from the energy capture unit to the energy storage unit, and the inflator may draw energy from the energy storage unit. In a second example, electrical energy may bypass the energy storage element and be transferred from the photovoltaic element to the inflator element. In this way, energy losses due to charging and discharging the energy storage element may be reduced in the second example compared to the first example. As a result, transferring energy directly from the photovoltaic element to the inflator element may be desired to increase efficiency (e.g., reduce energy lost compared to energy captured).

The method 400 proceeds to 406. At 406, the base is inflated to a target pressure. As described above, the inflation occurring at 406 may be powered by energy captured by the photovoltaic element. Thus, the self-deploying photovoltaic power system may self-inflate with energy captured thereby. For example, the target pressure may be a pressure at which the base holds an inflated shape (e.g., flat panel shape) and resists bending, folding, rolling, and the like. The target pressure may be less than or equal to a threshold pressure at which a valve (e.g., the separation valve 118 of FIGS. 1 and 7) releases air from the base. Thus, the pressure of the base may be maintained (e.g., until deflation is desired) at the target pressure, or between the target pressure and the threshold pressure. In this way, an angle of the photovoltaic element may be more easily controlled due to the flat surface of the base at the target pressure.

The method 400 proceeds after self-inflation to adjust the tilting element at 410. Adjusting the tilting element may be repeated as demanded during operation of the self-deploying photovoltaic power system. Adjusting the tilting element may include first receiving sensor signals at the controller at 412. For example, the sensors may detect a pressure (e.g., of air in the base and/or the tilting element), light exposure, and/or current (e.g., between the photovoltaic element and the energy storage element and/or between the photovoltaic element and the inflator element).

The method 400 proceeds to 414. At 414, the method includes determining whether a desired angle is greater than or less than a current angle, where the angle refers to the base angle, or the angle the base makes with a surface on which it rests (e.g., floats). The controller may use the received sensor signals from 412 to determine whether an angle increase or decrease is demanded, for example, using a method shown as a flowchart in FIG. 5.

The method 400 proceeds to 416, wherein pressure is optionally increased or decreased in the tilting element and pressure is maintained in the base, thereby respectively increasing or decreasing the base angle to reach the desired angle determined at 414. If neither an angle increase nor decrease is determined to be desired at 414, then 416 may not be performed. The control system may use the method 600 of FIG. 6 to increase or decrease the pressure in the tilting element.

The method 400 proceeds to 418, wherein the self-deploying photovoltaic power system is deflated and rolled. For examples, deflation may be initiated by a timer of the control system, or user input. Deflation may include the control system signaling to actuators to open the output port(s), and a valve between the base and the tilting element in examples where applicable (e.g., the separation valve 118 of FIGS. 1 and 7). Thus, air may be released from the self-deploying photovoltaic power system, allowing a user to roll the self-deploying photovoltaic power system into the compact form for transportation. Similar to the way inflation may be controlled to increase an efficiency of the photovoltaic element, deflation may also be controlled to increase the efficiency of the photovoltaic element. For example, the tilting element may be deflated first, followed by deflation of the base. As an example based on the schematic of FIG. 1, the outlet port 122 may be opened to deflate the tilting element, while the separation valve 118 fluidically separates the base 102 from the tilting element 104. Then when the tilting element is deflated (e.g., to below a threshold pressure) the separation valve 118 may be opened to allow the base to deflate and be rolled. In this way, the base may maintain an inflated shape during deflation of the tilting element such that the photovoltaic element continues to produce electrical energy while the tilting element deflates. Thus, folding, bending, and the like are prevented from interfering with energy capture during a larger portion of the deflation process, compared to allowing the base and tilting element to deflate concurrently. Therefore, energy capture may be increased by deflating in this way. As noted above, rolling may be performed manually or automatically.

Turning to FIG. 5, a flowchart of a method 500 is shown for determining whether a base angle (e.g., base angle 208 of FIGS. 2 and 3) may be increased or decreased to increase the efficiency of a photovoltaic element of a self-deploying photovoltaic power system (e.g., the examples shown in FIGS. 1-3 and 7-11). As described above, the method 500 may be included in a method (e.g., the method 400 of FIG. 4) of operating the self-deploying photovoltaic power system. As such, the method 500 may be initiated in response to sensors detecting a change in operating conditions. For example, a current sensor may detect a reduction in current from the photovoltaic element, and in response, a controller may determine if the efficiency may be increased by adjusting the tilting element. Additionally or alternatively, the method 500 may be initiated by user input, and/or in response to a timer of a control system. Sensor detection initiating the method 500 may be advantageous as sensors may be more sensitive than user input or timers (e.g., able to detect seasonal changes and have a faster response to change in conditions).

At 504, the method 500 determines whether the energy being captured by the photovoltaic element is greater than a threshold (e.g., amount, rate, etc.). For example, a current sensor may directly measure the current generated at the photovoltaic element and compare the current to a threshold current. Alternatively, a charge percentage of an energy storage element (e.g., a battery) may be used to determine whether the stored energy amount is above a threshold amount.

If it is determined that the energy captured by the photovoltaic element is greater than the threshold (YES) at 504, the method 500 proceeds to 510. At 510, the method includes determining that maintaining the base angle is demanded. For example, if the current base angle is approximately the same as the desired base angle, the base angle may be maintained. Maintaining the base angle may include not sending a signal to adjust inflation level of the tilting element.

If it is determined that the energy captured by the photovoltaic element is less than the threshold (NO) at 504, the method 500 proceeds to 506. At 506, method 500 includes determining whether the tilting element is deflated. For example, a pressure sensor may detect the pressure of the air inside the tilting element to determine if it is deflated.

If it is determined that the tilting element is deflated (YES) at 506, the method 500 proceeds to 512. At 512, method 500 includes determining that an angle increase is demanded. For example, the energy captured by the photovoltaic element may be increased by adjusting the tilting element as determined at 504. As a result, the tilting element is deflated as determined at 506. In such a scenario, the current base angle may be approximately zero.

If it is determined that the tilting element is not deflated (NO) at 506, the tilting element may be at least partially inflated. Thus, a base angle increase or decrease may occur and the method 500 proceeds to 508, wherein it is determined whether the sun is rising or setting in order to determine whether an angle increase or an angle decrease is demanded. Determining whether the sun is rising or setting may include detecting whether a preset time when the sun changes from rising to setting is reached by a clock or timer of the controller. Additionally or alternatively, sensors may be used to determine whether the sun is rising or setting.

If it is determined that the sun is setting (SETTING) at 508, the method proceeds to 512. At 512, the method includes determining that a base angle increase is demanded. As the sun sets, angles (e.g., with the surface on which the self-deploying photovoltaic power system sits) of solar rays incident on the photovoltaic element may be reduced. As a result, an increase in base angle may allow the solar rays to be closer to perpendicular with the photovoltaic element, thereby increasing efficiency of the photovoltaic element.

If it is determined that the sun is rising (RISING) at 508, the method 500 proceeds to 514, wherein it is determined that a base angle decrease is demanded. As the sun rises, angles of solar rays incident on the photovoltaic element may be increased, thus a decrease in base angle may allow the solar rays to be closer to perpendicular with the photovoltaic element, thereby increasing efficiency of the photovoltaic element.

The method 500 is an example, and methods serving a similar purpose may include more or fewer steps than described above. Further, there may be other factors taken into account in a method such as the method 500 in determining whether the base angle is maintained, increased, or decreased to increase efficiency of the photovoltaic element. For example, if there is minimal light exposure detected (e.g., below a threshold amount of light), for example at night, the method 500 may demand maintaining the current base angle because adjusting the base angle may not increase efficiency in such a scenario.

Turning to FIG. 6, a flowchart of a method 600 is shown for adjusting a base angle of a self-deploying photovoltaic power system. For example, the method 600 may be performed subsequently and according to a base angle adjustment demand (e.g., increasing, or decreasing the base angle) resulting from the method 500 of FIG. 5. The method 600 may not be performed if maintaining the base angle is demanded.

At 602, the method determines whether increasing or decreasing the base angle is demanded. For example, the method 500 of FIG. 5 may be used to determine the base angle adjustment demand.

If it is determined at 602 that a base angle decrease is demanded, the method 600 proceeds to 604, wherein a valve is opened to deflate. For example, the valve may be an outlet port of the tilting element (e.g., the outlet port 122 of FIGS. 1, 7, and 8). In this way, air may be released from the tilting element, thus reducing an inflation level thereof, and ultimately reducing the base angle.

The method 600 proceeds to 606, wherein the valve is closed when a target angle is reached. For example, a target angle may be reached when a desired pressure is reached in the tilting element. Thus, sensor signals (e.g., pressure sensor signals) may initiate closing of the valve.

If it is determined at 602 that a base angle increase is demanded, the method 600 proceeds to 608, wherein the battery charge is determined. For example, battery current sensors may detect the charge and discharge currents of the energy storage element, and thus may be used in determining the charge of the energy storage element. Determining the charge may be useful in subsequent steps in order to operate efficiently.

The method 600 proceeds to 610, wherein air is added to the self-deploying photovoltaic power system by the inflator element in order to increase pressure in the tilting element. In some examples, electricity may be drawn from the energy storage element to power the inflator element. Thus, the charge determined at 608 may be taken into account when operating the inflator element to increase the base angle. For example, if the charge drops below a threshold (e.g., a predetermined tolerance programmed in memory of the controller), the controller may automatically pause inflation. In another example, if energy spent to power the inflator element exceeds energy captured by the photovoltaic element, the controller may temporarily stop inflating the tilting element. Thus, the charge may be incorporated into algorithms used to operate the self-deploying photovoltaic power system.

In some examples, air may be added to the tilting element via the base (e.g., the example shown in FIG. 1). Thus, the method 600 includes optionally opening a separation valve (e.g., the separation valve 118 of FIGS. 1 and 7) between the base and the tilting element. As described above, the valve may be pressure sensitive. Additionally or alternatively, the valve may be electric, and communicatively couple to the controller such that the controller may cause the valve to open and close on demand.

At 614, adding air is stopped when a target angle is reached, or when a stored charge (e.g., percentage of charge of the energy storage element) is below a threshold as described above. For example, the flow of air may be stopped at whichever occurs first of the target angle being reached and the stored charge dropping below a threshold.

The method 600 optionally includes closing the separation valve at 616. For example, if the separation valve was opened at 612 to allow air flow into the tilting element, the separation valve may be closed at 616 when air flow is no longer demanded. However, if a separation valve was not opened (e.g., if operating a self-deploying photovoltaic power system with separate inlet ports for the base and the tilting elements such as shown in FIG. 8), closing a separation valve may not be demanded.

The method 600 is exemplary and non-limiting. Variations on the method 600 may include further steps to achieve a desired base angle. The method 600 may be used to increase efficiency of the photovoltaic element by aligning the photovoltaic element perpendicularly to incident light, however, other methods may be used for a similar purpose. Further, the method 600 may maximize overall efficiency of the self-deploying photovoltaic power system by considering the charge (e.g., percentage, amount, rate) of the energy storage element.

The technical effect of the systems and methods disclosed herein for self-deploying photovoltaic power systems is to provide a portable, rechargeable power source that is adequate for applications in remote environments, such as rural areas and/or on a body of water, and may be compacted for transport. To achieve this, the base and the tilting element are inflatable, and may be rolled when deflated. Further, the photovoltaic element may be rolled without incurring degradation to the photovoltaic material. Further still, due to the self-deploying nature of the power system disclosed herein, the base may be self-inflatable, and able to self-regulate the angle of tilting by adjusting the tilting element in response to environmental conditions in order to increase efficiency of the self-deploying photovoltaic power system. The self-deploying photovoltaic power system may further be adapted to connect in series and/or parallel with one another, and thus scalable to meet energy demands for a variety of applications. The connection in series and/or parallel will allow for a larger array of the self-deploying photovoltaic power systems, which may provide secondary benefits such as evaporation control when used over a body of water (e.g., lake, reservoir, or pond).

The disclosure also provides support for a self-deploying photovoltaic power system, comprising: an inflatable base, wherein the base is a dropstitch panel with one or more inlet ports, a photovoltaic element arranged on, or embedded within, a surface of the inflatable base, wherein the photovoltaic element comprises photovoltaic material, an inflator element adapted to inflate the base, and an energy storage element configured to store energy captured by the photovoltaic element. In a first example of the system, the system further comprises: an inflatable tilting element with one or more outlet ports, wherein the tilting element is adapted to adjust an angle of the base. In a second example of the system, optionally including the first example, the system further comprises: a separation valve between the base and the tilting element adapted to fluidically separate the base and the tilting element, wherein the separation valve is pressure sensitive and electrically actuated. In a third example of the system, optionally including one or both of the first and second examples, the tilting element comprises one or more inflatable cylinders adapted to adjust an angle of incident light in one or more degrees of freedom. In a fourth example of the system, optionally including one or more or each of the first through third examples, the photovoltaic element comprises photovoltaic material integrated into yarn used to construct the base. In a fifth example of the system, optionally including one or more or each of the first through fourth examples, the photovoltaic element comprises photovoltaic material printed, laminated, or adhered onto dropstitch material. In a sixth example of the system, optionally including one or more or each of the first through fifth examples, the base is coated with a sealing layer over the photovoltaic element. In a seventh example of the system, optionally including one or more or each of the first through sixth examples, the self-deploying photovoltaic power system is coupled to a vehicle via a coupling. In an eighth example of the system, optionally including one or more or each of the first through seventh examples, the coupling can be engaged and disengaged. In a ninth example of the system, optionally including one or more or each of the first through eighth examples, the outlet ports are adapted to couple to inlet ports of another self-deploying photovoltaic power system in parallel and/or in series. In a tenth example of the system, optionally including one or more or each of the first through ninth examples, the tilting element is adapted to adjust a base angle to align the photovoltaic element perpendicularly or closer to perpendicularly with incident light. In an eleventh example of the system, optionally including one or more or each of the first through tenth examples, the inflator element is adapted to inflate the base using a portion of energy captured by the photovoltaic element.

The disclosure also provides support for a method for operating a self-deploying photovoltaic power system, comprising: self-inflating the self-deploying photovoltaic power system, and deflating and rolling the self-deploying photovoltaic power system. In a first example of the method, the method further comprises: adjusting a tilting element by increasing or decreasing pressure in the tilting element after self-inflating and before deflating. In a second example of the method, optionally including the first example, the method further comprises: both of: capturing and storing energy after self-inflating the self-deploying photovoltaic power system, and capturing and storing energy before deflating the self-deploying photovoltaic power system. In a third example of the method, optionally including one or both of the first and second examples, the method further comprises: directing the captured and stored energy to a device. In a fourth example of the method, optionally including one or more or each of the first through third examples, the captured and stored energy is directed to the device using wireless power transfer or conductive elements. In a fifth example of the method, optionally including one or more or each of the first through fourth examples, self-inflating comprises: inflating a base of the self-deploying photovoltaic power system to unroll the base, capturing energy to continue inflating, and further inflating the base to a target pressure using the captured energy. In a sixth example of the method, optionally including one or more or each of the first through fifth examples, self-inflating comprises: inflating a base of the self-deploying photovoltaic power system to unroll the base, capturing energy to continue inflating, further inflating the base to a target pressure using the captured energy, and inflating the tilting element using the captured energy. In a seventh example of the method, optionally including one or more or each of the first through sixth examples, increasing pressure in the tilting element comprises: determining an amount of charge stored in an energy storage element, and adding an amount of air using an inflator element according to the determined amount of charge.

FIGS. 1-3 and 7-11 show example configurations with relative positioning of the various components. FIGS. 2 and 3 are shown approximately to scale; though other relative dimensions may be used. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Additionally, elements co-axial with one another may be referred to as such, in one example. Further, elements shown intersecting one another may be referred to as intersecting elements or intersecting one another, in at least one example. Further still, an element shown within another element or shown outside of another element may be referred as such, in one example. In other examples, elements offset from one another may be referred to as such.

Features described as axial may be approximately parallel with an axis referenced unless otherwise specified. As used herein, the terms “approximately” is construed to mean plus or minus five percent of the range unless otherwise specified. Features described as counter-axial may be approximately perpendicular to the axis referenced unless otherwise specified. Features described as radial may circumferentially surround or extend outward from an axis, such as the axis referenced, or a component or feature described prior as being radial to a referenced axis, unless otherwise specified.

Features described as longitudinal may be approximately parallel with an axis that is longitudinal. A lateral axis may be normal to a longitudinal axis. Features described as lateral may be approximately parallel with the lateral axis. A vertical axis may be normal to a lateral axis and a longitudinal axis. Features described as vertical may be approximately parallel with a vertical axis.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A self-deploying photovoltaic power system, comprising:
an inflatable base, wherein the base is a dropstitch panel with one or more inlet ports;
a photovoltaic element arranged on, or embedded within, a surface of the inflatable base, wherein the photovoltaic element comprises photovoltaic material;
an inflator element adapted to inflate the base; and
an energy storage element configured to store energy captured by the photovoltaic element.

2. The self-deploying photovoltaic power system of claim 1, further comprising an inflatable tilting element with one or more outlet ports, wherein the tilting element is adapted to adjust an angle of the base.

3. The self-deploying photovoltaic power system of claim 2, further comprising a separation valve between the base and the tilting element adapted to fluidically separate the base and the tilting element, wherein the separation valve is pressure sensitive and electrically actuated.

4. The self-deploying photovoltaic power system of claim 2, wherein the tilting element comprises one or more inflatable cylinders adapted to adjust an angle of incident light in one or more degrees of freedom.

5. The self-deploying photovoltaic power system of claim 1, wherein the photovoltaic element comprises photovoltaic material integrated into yarn used to construct the base.

6. The self-deploying photovoltaic power system of claim 1, wherein the photovoltaic element comprises photovoltaic material printed, laminated, or adhered onto dropstitch material.

7. The self-deploying photovoltaic power system of claim 1, wherein the base is coated with a sealing layer over the photovoltaic element.

8. The self-deploying photovoltaic power system of claim 1, wherein the self-deploying photovoltaic power system is coupled to a vehicle via a coupling.

9. The self-deploying photovoltaic power system of claim 8, wherein the coupling can be engaged and disengaged.

10. The self-deploying photovoltaic power system of claim 2, wherein the outlet ports are adapted to couple to inlet ports of another self-deploying photovoltaic power system in parallel and/or in series.

11. The self-deploying photovoltaic power system of claim 2, wherein the tilting element is adapted to adjust a base angle to align the photovoltaic element perpendicularly or closer to perpendicularly with incident light.

12. The self-deploying photovoltaic power system of claim 1, wherein the inflator element is adapted to inflate the base using a portion of energy captured by the photovoltaic element.

13. A method for operating a self-deploying photovoltaic power system, comprising:
self-inflating the self-deploying photovoltaic power system; and
deflating and rolling the self-deploying photovoltaic power system.

14. The method of claim 13, further comprising adjusting a tilting element by increasing or decreasing pressure in the tilting element after self-inflating and before deflating.

15. The method of claim 13, further comprising both of:
capturing and storing energy after self-inflating the self-deploying photovoltaic power system; and
capturing and storing energy before deflating the self-deploying photovoltaic power system.

16. The method of claim 15, further comprising directing the captured and stored energy to a device.

17. The method of claim 16, wherein the captured and stored energy is directed to the device using wireless power transfer or conductive elements.

18. The method of claim 13, wherein self-inflating comprises:
inflating a base of the self-deploying photovoltaic power system to unroll the base;
capturing energy to continue inflating; and
further inflating the base to a target pressure using the captured energy.

19. The method of claim 14, wherein self-inflating comprises:
inflating a base of the self-deploying photovoltaic power system to unroll the base;
capturing energy to continue inflating;
further inflating the base to a target pressure using the captured energy; and
inflating the tilting element using the captured energy.

20. The method of claim 14, wherein increasing pressure in the tilting element comprises:
determining an amount of charge stored in an energy storage element; and
adding an amount of air using an inflator element according to the determined amount of charge.
